(19) United States
(12) Patent Application Publication
(10) Pub. No.: US 2013/0332171 A1
(43) Pub. Date: Dec. 12, 2013

(54) Bandwidth Extension via Constrained Synthesis

(71) Applicants: Carlos Avendano, Campbell, CA (US); Marios Athineos, San Francisco, CA (US); Ethan Duni, Mountain View, CA (US)

(72) Inventors: Carlos Avendano, Campbell, CA (US); Marios Athineos, San Francisco, CA (US); Ethan Duni, Mountain View, CA (US)

(21) Appl. No.: 13/916,388

(22) Filed: Jun. 12, 2013

Related U.S. Application Data
(60) Provisional application No. 61/658,831, filed on Jun. 12, 2012.

(51) Int. Cl. G10L 19/12

(52) U.S. Cl. CPC G10L 19/12
USPC 704/264; 704/268

(57) ABSTRACT

Audio signal bandwidth extension may be performed on a narrow bandwidth signal received from a remote source over the audio communication network. The narrow band signal bandwidth may be extended such that the bandwidth is greater than that of the audio communication network. The signal may be extended by synthesizing an audio signal having spectral values within an extended bandwidth from synthetic components. The synthetic components may be generated using parameters derived from original narrowband audio signal. The audio signal may be synthesized in the form of an excitation signal and vocal tract envelope. The excitation signal and vocal tract may be extended independently. In various embodiments, excitation components may be derived from constrained synthesis using a constraint filter with nulls in regions where the extension is desired.

### CROSS-REFERENCE TO RELATED APPLICATIONS

This application claims the benefit of U.S. Provisional Application Ser. No. 61/658,831, filed Jun. 12, 2012. The disclosure of the aforementioned application is incorporated herein by reference in its entirety for all purposes.

### BACKGROUND

Audio communication networks often have bandwidth limitations affecting the quality of the audio transmitted over the networks. For example, telephone channel networks limit the bandwidth of audio signal frequencies to between 300 Hz to 3500 Hz. As a result, speech transmitted using only this limited bandwidth sounds thin and dull due to the lack of low and high frequency content in the audio signal, thereby limiting speech quality.

A challenge in bandwidth enhancement systems is creating a natural and perceptually fused enhancement signal with frequency components outside the bandwidth of the original narrowband signal.

One of the common methods for creating higher frequency components may include (optionally without low-pass filtering) using the narrowband signal to create spectrally-folded energy in the higher band. This method may create a distinct distortion due to the aliasing which is difficult to (e.g., perceptually) conceal. Additionally, this method may fail to cover spectral holes near the folding frequency (e.g., a hole from 3.5 to 4.5 kHz for telephone speech).

Other methods may copy harmonics of the narrowband signal and transpose the harmonics to the higher empty frequency bands. These methods may rely (heavily) on accurate pitch detection for computing the translation parameters, and also require explicit phase alignment for achieving perceptual fusion.

### SUMMARY

Embodiments of the present disclosure may address limitations present in the methods described above. Embodiments may, for example, create missing excitation components and may include envelope shaping methods to produce the final excitation-filter model output.

Embodiments of the present disclosure may treat the empty frequency bands where new components are sought as missing data regions. For example, for extending the higher band of telephone speech, the signal may be resampled to the desired rate (e.g., 16 kHz) with the frequency band above 3.5 kHz being treated as missing data. Signal reconstruction methods may be used to restore missing components.

In some embodiments, the methods described herein may be applied to the Linear Predictive Coding (LPC) residual of a resampled narrowband signal. The reconstruction method may be based at least on the properties of Code-Excited Linear Prediction (CELP) coding, where a Long-Term Predictor (LTP) and a fixed codebook may be used in an analysis-by-synthesis framework for replicating the residual signal with constrained degrees of freedom. In general, a “perceptual” filter may be applied to a matching error signal for shaping coding noise. Such a perceptual filter may be generally derived from at least the input envelope parameters.

Embodiments of the present disclosure may augment the perceptual filter by cascading it with a filter whose shape is similar to the passband characteristics of the telephone channel (e.g., the same filter that rejected the missing components). Such a filter may place emphasis on the present components and de-emphasize the missing components, so that the LTP creates a fullband signal (i.e., increased entropy) with the same periodicity as the narrowband input. A restored excitation signal may include estimates of the missing components and may be used to synthesize the enhancement signal using a bandwidth extended envelope filter.

Further embodiments of the present disclosure may include a non-transitory computer readable storage medium including a program executable by a processor to perform methods for extending a spectral bandwidth of an acoustic signal as described above.

### BRIEF DESCRIPTION OF THE DRAWINGS

FIG. 1 is a block diagram in which the present technology may be used.

FIG. 2 is a block diagram of an example audio device.

FIG. 3A is a plot of a narrowband audio signal spectrum, according to an example embodiment.

FIG. 3B is a plot of an extended audio signal spectrum, according to an example embodiment.

FIG. 4 is a block diagram of an example audio processing system.

FIG. 5 is a block diagram of an example bandwidth extension module.

FIG. 6 is a block diagram of a code-excited linear prediction processing module, according to an example embodiment.

FIG. 7 is a block diagram of an example synthesis module.

FIG. 8 is a flow chart of an example method for extending bandwidth of audio signals.

FIG. 9 illustrates an example computing system that may be used to implement an embodiment of the present disclosure.

### DETAILED DESCRIPTION

The present technology may extend the bandwidth of an audio signal received over an audio communication network with a limited bandwidth. The audio signal bandwidth extension may commence with receiving a narrow bandwidth signal from a remote source transmitted over the audio communication network. The narrow band signal bandwidth may then be extended such that the bandwidth is greater than that of the audio communication network.

The present technology may treat an empty frequency band in regions of the bandwidth extension as missing data and synthesize new components in the extended bandwidth based on a spectral envelope and excitation components. In the various embodiments, the spectral envelope for the narrow bandwidth may be mapped to the extended bandwidth using a statistical model, while the excitation components for the extended bandwidth may be generated by Code-Excited Linear Prediction (CELP) closed loop coding in an analysis-by-synthesis framework with constrained degrees of freedom. A perceptual filter used in the CELP closed loop coding may be based on a spectral envelop mapped to the extended bandwidth. Embodiments of the present disclosure may also provide for augmenting a perceptual filter by cascading the filter with a filter having a shape similar to the passband characteristics of the telephone channel.

Various embodiments may be practiced with any audio device configured to receive and/or provide audio such as, but not limited to, cellular phones, phone handsets, headsets, and conferencing systems. It should be understood that while some embodiments will be described in reference to operations of a cellular phone, the present technology may be practiced with any audio device.

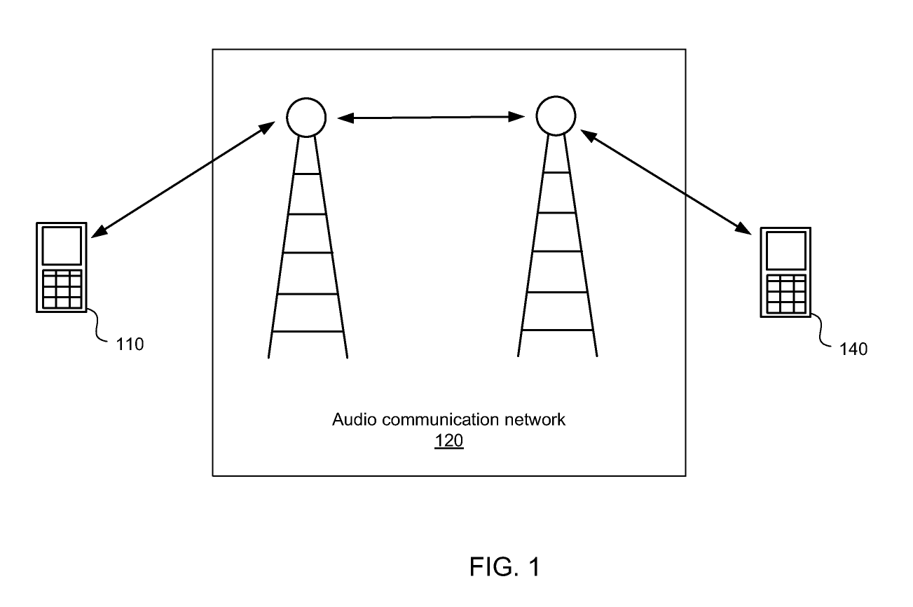

FIG. 1 is an example system for communications between audio devices. FIG. 1 includes a mobile device 110, a mobile device 140, and an audio communication network 120. Audio communication network 120 may communicate an audio signal between audio device 110 and audio device 140. The bandwidth of the audio signals sent between the audio devices maybe limited to between 300 Hz-3.500 Hz. Mobile devices 110 and 140, however, may output audio signals having a frequency outside the range allowed by the audio communication network, such as for example, between 200 Hz and 8000 Hz.

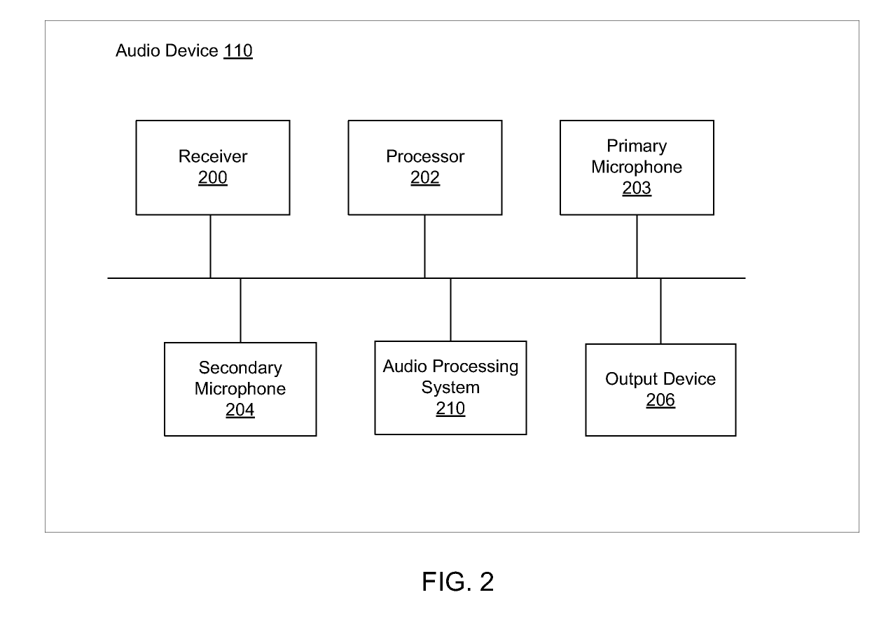

FIG. 2 is a block diagram of an example audio device 110. In the illustrated embodiment, the audio device 110 includes a receiver 200, a processor 202, a primary microphone 203, an optional secondary microphone 204, an audio processing system 210, and an output device 206, such as, for example, an audio transducer. The audio device 110 may include further or other components necessary for audio device 110 operations. Similarly, the audio device 110 may include fewer components performing similar or equivalent functions to those depicted in FIG. 2.

Processor 202 may execute instructions and modules stored in a memory (not illustrated in FIG. 2) of the audio device 110 to perform functionality described herein, including extending a spectral bandwidth of an audio signal. Processor 202 may include hardware and software implemented as a processing unit, which may process floating point operations and other operations for the processor 202.

The example receiver 200 is configured to receive an audio signal from the communications network 120. In the illustrated embodiment, the receiver 200 may include an antenna device (not shown on FIG. 2). The audio signal may then be forwarded to the audio processing system 210, which processes the audio signal. This processing may include extending a spectral bandwidth of a received audio signal. In some embodiments, the audio processing system 210 may, for example, process data stored on a storage medium such as a memory device or an integrated circuit to produce a bandwidth extended acoustic signal for playback. In some embodiments, the audio processing system 210 may be cloud-based. The audio processing system 210 is discussed in more detail below.

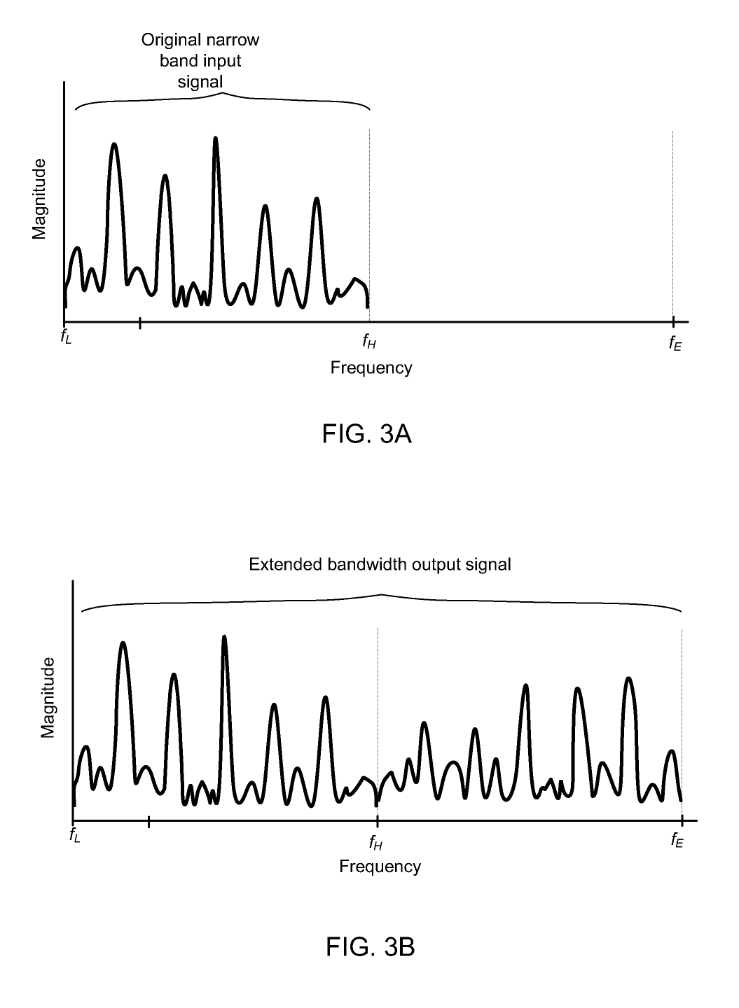

The plot of FIG. 3A illustrates an example of an original narrow bandwidth signal having frequency values between a low frequency f_{L} and a high frequency f_{H}. The original narrow bandwidth audio signal is processed by audio processing system 210 to extend the frequency spectrum of the received audio signal. A plot of an extended signal spectrum is shown in FIG. 3B. The signal spectrum in FIG. 3A is extended to cover higher frequencies up to a boundary frequency f_{E}. The present technology may be applied to extend a bandwidth to a lower frequencies region as well.

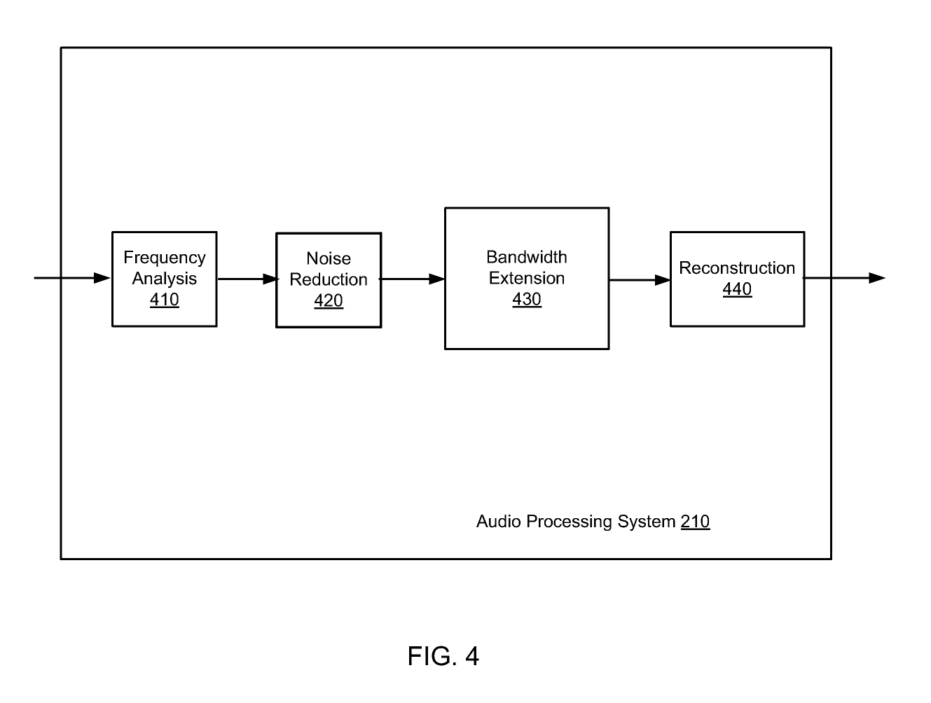

FIG. 4 is a block diagram of an audio processing system 210, according to an example embodiment. The audio processing system 210 of FIG. 4 may provide more detail for the audio processing system 210 of FIG. 2. The audio processing system 210 in FIG. 4 includes frequency analysis module 410, noise reduction module 420, bandwidth extension module 430, and reconstruction module 440.

Audio processing system 210 may receive an audio signal including one or more time-domain input signals and provide the input signals for frequency analysis module 410. Audio processing system 210 may receive a narrow band acoustic signal from audio communication network 120.

The input signals may be received from receiver 200. Frequency analysis module 410 may generate frequency sub-bands from the time-domain signals and output the frequency sub-band signals.

Noise reduction module 420 may receive the narrow band signal (comprised of frequency sub-bands) and provide a noise reduced version to bandwidth extension module 430. An audio processing system suitable for performing noise reduction by noise reduction module 420 is discussed in more detail in U.S. patent application Ser. No. 12/832,901, titled “Method for Jointly Optimizing Noise Reduction and Voice Quality in a Mono or Multi-Microphone System, filed on Jul. 8, 2010, the disclosure of which is incorporated herein by reference for all purposes.

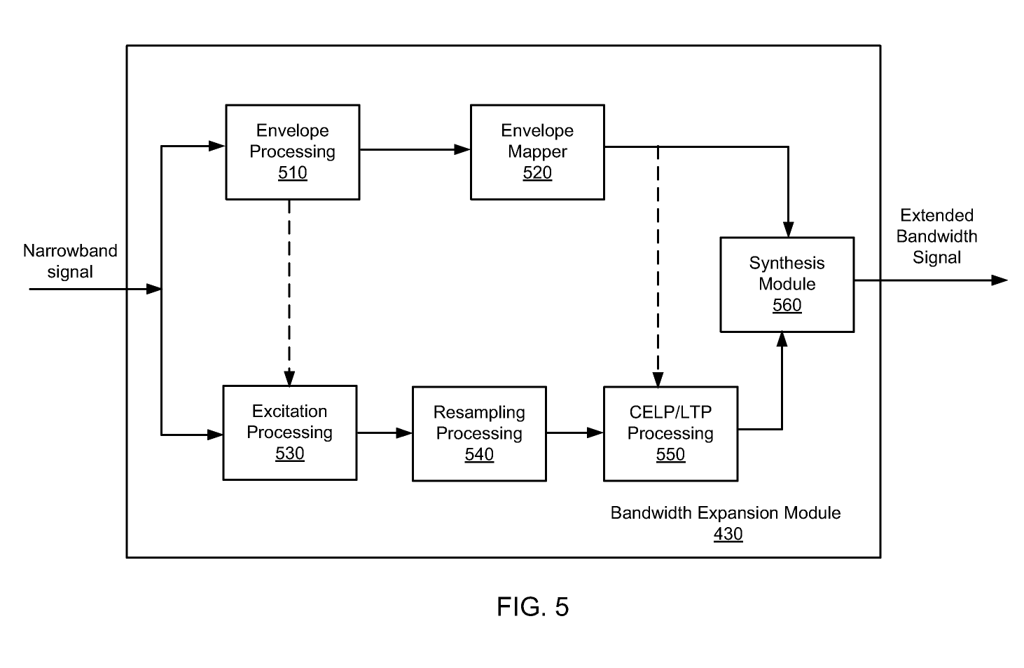

Bandwidth extension module 430 may process the noise reduced narrow band signal to extend the bandwidth of the signal. Bandwidth extension module 430 is discussed in more details below with reference to FIG. 5.

Reconstruction module 440 may receive signals from bandwidth extension module 430 and reconstruct synthetically generated extended bandwidth signal into a single audio signal.

FIG. 5 is a block diagram of a bandwidth extension module 430, according to an example embodiment. The bandwidth extension module 430 of FIG. 5 may provide more detail for bandwidth extension module 430 in FIG. 4. A narrow band signal is received by bandwidth extension module 430. The narrow band signal is processed by envelope processing module 510. Envelope processing module 510 may construct an envelope component from peaks in the received signal. The envelope component created from the narrow band signal peaks may be provided to envelope mapper module 520 and excitation processing module 530.

The envelope mapper module 520 may receive the spectral envelope component created from narrow band signal and may generate a spectral envelope component for the extended bandwidth signal. The extended bandwidth envelope may be represented using a Line Spectral Frequencies (LSF) model.

The excitation processing module 530 may generate the Linear Predictive Coding (LPC) residual of the narrowband signal by removing the spectral envelope component from the narrowband signal. The LPC residual data may be passed to resampling processing module 540. The resampling processing module 540 may receive the LPC residual of the narrowband signal. The signal may be resampled to a desired rate.

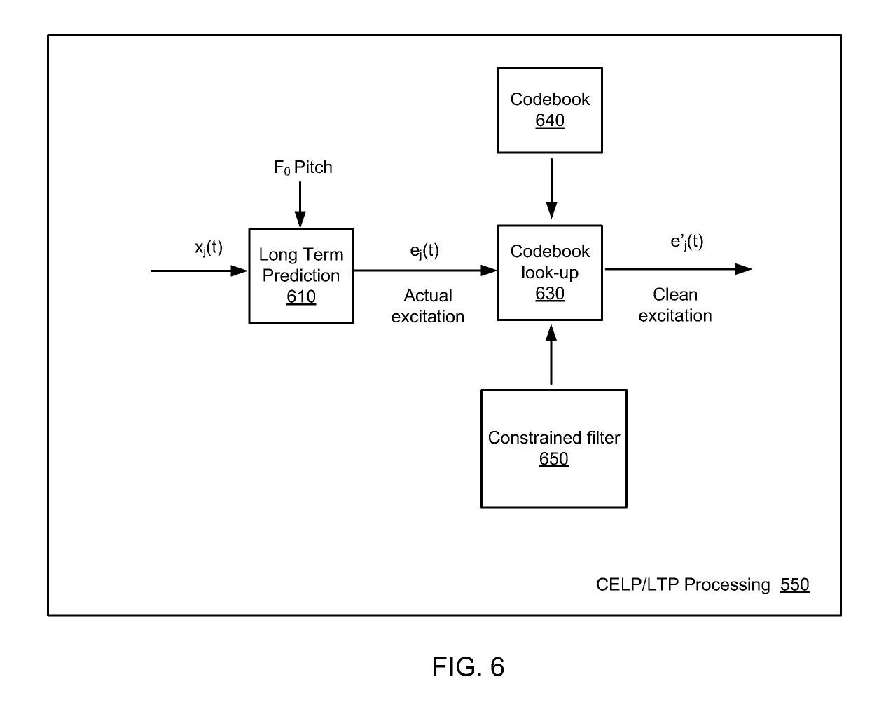

The CELP/LTP processing module 550 may receive resampled LPC residual signal from resampling processing module 540 (and extended bandwidth spectral envelope for the current frame from envelope mapper module 520) to determine an excitation component for the extended band signal. The CELP/LTP processing module 550 is discussed in more detail below with reference to FIG. 6.

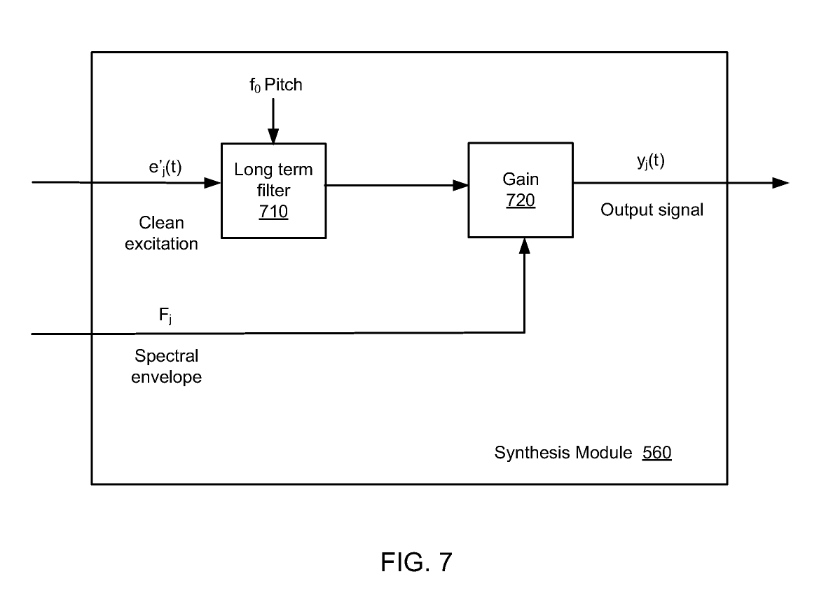

Synthesis module 560 may receive an excitation signal for the extended bandwidth from CELP/LTP processing module 550 and an extended bandwidth spectral envelope for the current frame from envelope mapper module 520. Synthesis module 560 may generate and output a synthesized audio signal having spectral values within the extended bandwidth (i.e., an Extended Bandwidth Signal). Synthesis module 560 is discussed in more detail below and in FIG. 7.

FIG. 6 is a block diagram of a CELP/LTP processing module 550. The CELP/LTP processing module 550 of FIG. 6 may provide more details for the CELP/LTP processing module 550 of FIG. 5 and may include at least long term prediction module 610, codebook look-up 630, and codebook module 640.

Long term prediction model 610 may receive current frame band signals as well as pitch data and output an actual excitation for each band. The pitch may be determined based on audio signal data. An example method for determining a pitch is described in U.S. patent application Ser. No. 12/860,043, entitled “Monaural Noise Suppression Based on Computational Auditory Scene Analysis,” filed on Aug. 20, 2010, the disclosure of which is incorporated herein by reference for all purposes.

The actual excitations are provided by long term prediction module 610 to codebook look-up module 630. Codebook look-up module 630 receives the actual excitations, and compares them to a set of excitation values associated with a clean signal and stored in codebook 640. The set of clean excitation data stored in codebook 640 may represent different types of speech. Codebook look-up module 630 may select the clean excitation value set that best matches the reliable excitation values and provide the complete excitation data associated with the matching excitation value set e′ⱼ(t) as an output for the CELP/LTP processing module 550.

A weighted error metric may be used inside codebook look-up module 630 in order to find the best matched excitation set. The weighting parameters of the error metric can be based on a perceptual filter. The perceptual filter may be constructed using spectral envelope for extended bandwidth provided by envelope mapper module 520 (coupling between these modules is shown in FIG. 5).

In some embodiments, additional constraints may be applied in reconstruction of the excitation components by codebook look-up module 630. The perceptual filter may be augmented by cascading the filter with a constrained filter 650. The constrained filter 650 may have nulls in the regions of the extension of the bandwidth. The constrained filter 650 may be of shape similar to a shape of a passband characteristic of a telephone channel.

FIG. 7 is a block diagram of a synthesis module 560, according to an example embodiment. Synthesis module 560 of FIG. 7 provides more detail for the synthesis module 560 of FIG. 5 and includes long term filter 710 and gain 720. Long term filter 710 receives clean excitation signals for each band in the current frame and imparts the original pitch of each band back into the excitation signal. Gain module 720 receives the clean excitation signals having the imparted pitch and the spectral envelope signal for extended bandwidth and applies the clean envelope spectrum to the excitation signals to control the amplitude of the excitation signals. Gain module 720 then outputs an extended bandwidth signal.

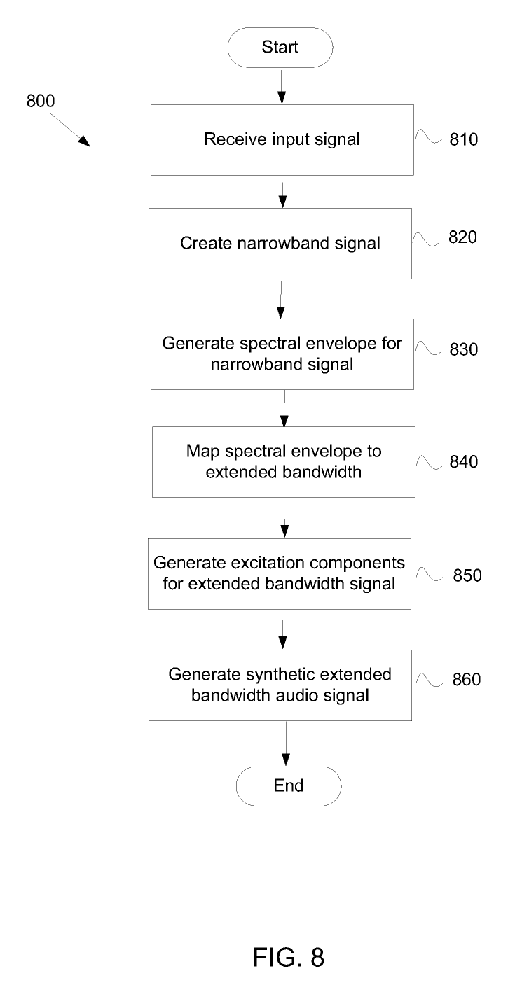

FIG. 8 is a flow chart 800 of an example method for synthesizing an extended bandwidth signal. The method may commence with an input signal received at operation 810. The signal may be received from receiver 200 of audio device 110. Narrowband signals may be created at operation 820. The narrowband signals may be generated from the input signals by a frequency analysis module 410 within the audio processing system 210.

Envelope processing may be performed at operation 830. The envelope processing may generate a spectral envelope component for the narrowband signal. The envelope mapping process may be carried out at operation 840. The envelope mapping process may map the spectral envelope for the narrowband signal to the extended bandwidth.

Excitation processing may be performed at operation 850. The excitation processing may generate excitation components for the extended bandwidth signal. The excitation components may be generated by CELP/LTP processing module 550 within bandwidth extension module 430.

Synthesis processing may be performed at operation 860. The synthesis processing may generate an extended band signal using the spectral envelope generated by envelope mapper module 520 and excitation components generated by CELP/LTP processing module 550 within bandwidth extension module 430.

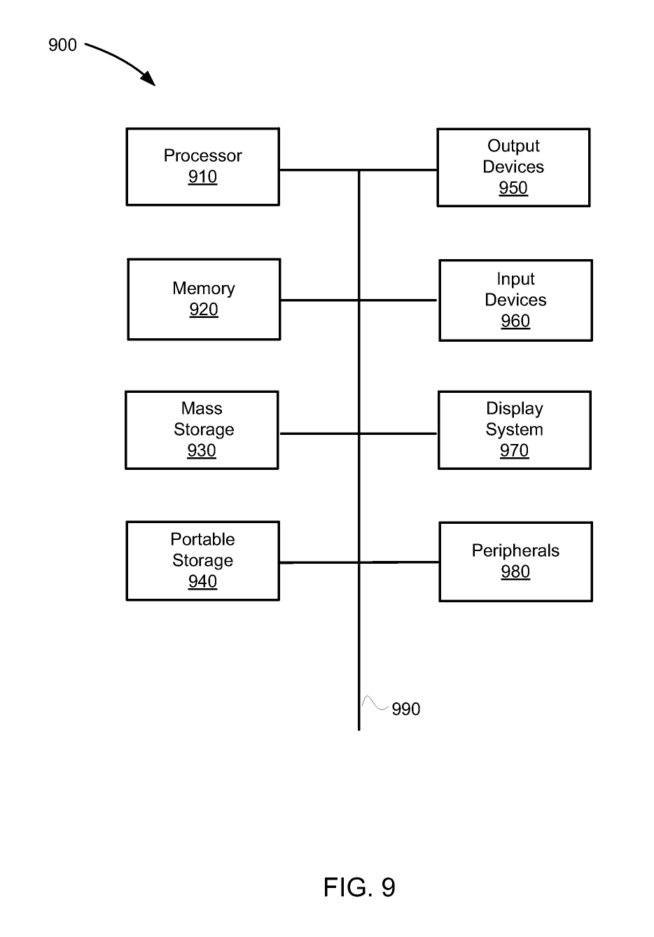

FIG. 9 illustrates an example computing system 900 that may be used to implement an embodiment of the present disclosure. The system 900 of FIG. 9 may be implemented in the contexts of the likes of computing systems, networks, servers, or combinations thereof. The computing system 900 of FIG. 9 includes one or more processors 910 and main memory 920. Main memory 920 stores, in part, instructions and data for execution by processor 910. Main memory 920 may store the executable code when in operation. The system 900 of FIG. 9 further includes a mass storage device 930, portable storage medium drive(s) 940, output devices 950, user input devices 960, a display system 970, and peripheral devices 980.

The components shown in FIG. 9 are depicted as being connected via a single bus 990. The components may be connected through one or more data transport means. Processor 910 and main memory 920 may be connected via a local microprocessor bus, and the mass storage device 930, peripheral device(s) 980, portable storage device 940, and display system 970 may be connected via one or more input/output (I/O) buses.

Mass storage device 930, which may be implemented with a magnetic disk drive or an optical disk drive, is a non-volatile storage device for storing data and instructions for use by processor 910. Mass storage device 930 may store the system software for implementing embodiments of the present disclosure for purposes of loading that software into main memory 920.

Portable storage device 940 operates in conjunction with a portable non-volatile storage medium, such as a floppy disk, compact disk, digital video disc, or USB storage device, to input and output data and code to and from the computer system 900 of FIG. 9. The system software for implementing embodiments of the present disclosure may be stored on such a portable medium and input to the computer system 900 via the portable storage device 940.

Input devices 960 provide a portion of a user interface. Input devices 960 may include an alphanumeric keypad, such as a keyboard, for inputting alpha-numeric and other information, or a pointing device, such as a mouse, a trackball, stylus, or cursor direction keys. Input devices 960 may also include a touchscreen. Additionally, the system 900 as shown in FIG. 9 includes output devices 950. Suitable output devices include speakers, printers, network interfaces, and monitors.

Display system 970 may include a liquid crystal display (LCD) or other suitable display device. Display system 970 receives textual and graphical information, and processes the information for output to the display device.

Peripherals 980 may include any type of computer support device to add additional functionality to the computer system. Peripheral device(s) 980 may include a modem or a router.

The components provided in the computer system 900 of FIG. 9 are those typically found in computer systems that may be suitable for use with various embodiments of the present disclosure and are intended to represent a broad category of such computer components that are well known in the art. Thus, the computer system 900 of FIG. 9 may be a personal computer, hand held computing system, telephone, mobile computing system, workstation, server, minicomputer, mainframe computer, or any other computing system and may be cloud-based. The computer may also include different bus configurations, networked platforms, multi-processor platforms, etc. Various operating systems may be used including Unix, Linux, Windows, Mac OS, Palm OS, Android, iOS (known as iPhone OS before June 2010), QNX, and other suitable operating systems.

It is noteworthy that any hardware platform suitable for performing the processing described herein is suitable for use with the embodiments provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), Blu-ray Disc (BD), any other optical storage medium, RAM, PROM, EPROM, EEPROM, FLASH memory, and/or any other memory chip, module, or cartridge.

What is claimed is:

1. A method for extending bandwidth of an audio signal, the method comprising:
receiving, by a processor, an audio signal having spectral values within a narrow bandwidth;
determining, via instructions stored in a memory and executed by the processor, synthetic components of an audio signal having spectral values within an extended bandwidth; and
synthesizing, via instructions stored in the memory and executed by the processor and based on the synthetic components, an extended audio signal having spectral values within an extended bandwidth.

2. The method of claim 1, wherein the extended bandwidth includes a frequency outside the narrow bandwidth.

3. The method of claim 1, wherein the synthetic components are divided into a spectral envelope and excitation components.

4. The method of claim 3, wherein the spectral envelope and the excitation components are estimated independently.

5. The method of claim 3, wherein the spectral envelope for the extended bandwidth signal is estimated based on information derived from the spectral envelope of the narrow bandwidth signal.

6. The method of claim 3, wherein the spectral envelope for the extended bandwidth is estimated based on a statistical model, the statistical model mapping the spectral envelope for the narrow bandwidth signal to the spectral envelope for the extended bandwidth signal.

7. The method of claim 3, wherein synthesizing includes applying a gain to excitation components of the extended bandwidth signal, the gain being based on the spectral envelope of the extended bandwidth signal.

8. The method of claim 3, wherein the excitation components are derived using a constrained filter, the constrained filter having nulls in regions of extension of the narrow bandwidth.

9. The method of claim 8, wherein the constrained filter has a shape similar to a shape of a passband filter of a telephone channel.

10. A system for bandwidth extension of an audio signal, the system comprising:
a processor; and
a memory communicatively coupled with the processor, the memory storing instructions which when executed by the processor performs a method comprising:
receiving an audio signal having spectral values within a narrow bandwidth;
determining synthetic components of an audio signal having spectral values within an extended bandwidth; and
synthesizing, based on the synthetic components, the extended audio signal having spectral values within the extended bandwidth.

11. The system of claim 10, wherein the extended bandwidth includes a frequency outside of the narrow bandwidth.

12. The system of claim 10, wherein the synthetic components are divided into a spectral envelope and excitation components.

13. The system of claim 12, wherein the spectral envelope and the excitation components are estimated independently.

14. The system of claim 12, wherein the spectral envelope for the extended bandwidth signal is estimated based on information derived from the spectral envelope of the narrow bandwidth signal.

15. The system of claim 12, wherein the spectral envelope is estimated based on a statistical model, the statistical model mapping the spectral envelope for the narrow bandwidth signal to the spectral envelope of the extended bandwidth signal.

16. The system of claim 12, wherein synthesizing includes applying a gain to excitation components of the extended bandwidth signal, the gain being based on the spectral envelope of extended bandwidth signal.

17. The system of claim 12, wherein the excitation components are derived using a constrained filter with nulls in regions of extension of the narrow bandwidth.

18. The system of claim 17, wherein the constrained filter has a shape similar to a shape of a passband filter of a telephone channel.

19. A non-transitory computer-readable storage medium having embodied thereon a program, the program being executable by a processor to perform a method for bandwidth extension, the method comprising:
receiving an audio signal having spectral values within a narrow bandwidth;
determining synthetic components of an audio signal having spectral values within an extended bandwidth; and
synthesizing, based on the synthetic components, the extended audio signal having spectral values within the extended bandwidth.

20. The non-transitory computer-readable storage medium of claim 19, wherein the extended bandwidth includes a frequency outside the narrow bandwidth.
